(19) United States
(12) Patent Application Publication
(10) Pub. No.: US 2024/0046116 A1
(43) Pub. Date: Feb. 8, 2024

(54) Method and Device for Collecting Dialog Data

(71) Applicant: Mingri Dream (Beijing) Technology Co., Ltd, Beijing (CN)

(72) Inventors: Tao Mingliang, Beijing (CN); Zhang Mozhi, Beijing (CN); Shi Xinhong, Beijing (CN)

(21) Appl. No.: 18/165,086

(22) Filed: Feb. 6, 2023

(30) Foreign Application Priority Data
Aug. 8, 2022 (CN) 202210945078.5

(51) Int. Cl. G06N 5/022

(52) U.S. Cl. CPC G06N 5/022

(57) ABSTRACT

A method relates to collecting dialog data between two users and assisting users in collecting dialog data includes acquiring a feature of a dialog subject of a first dialog, acquiring, according to the feature or according to the feature and dialog data received from the two users, first knowledge information, and providing, based on the first knowledge information, background knowledge related to the first dialog to the two users.

### CROSS-REFERENCE TO RELATED APPLICATION

This application claims priority to Chinese Patent Application No. 202210945078.5 filed on Aug. 8, 2022, which is hereby incorporated by reference in its entirety.

### TECHNICAL FIELD

The present disclosure relates to the field of data collection, in particular to a method and a device for collecting dialog data.

### BACKGROUND

Artificial Intelligence (AI) is a hot research area nowadays. From the advent of AI to the 1980s, most AI systems were implemented by manual programming, often using declarative, functional, or other high-level languages, which form the basis of most knowledge representations. At present, the main AI fields comprise problem solving, machine learning, natural language, speech recognition, vision and robotics. As technology has advanced, many machine learning methods have been investigated, comprising neural networks, biology, evolutionary techniques, and mathematical modeling, wherein deep learning has proven to be an effective method for building and training neural networks to solve complex problems.

Regardless of the method used, current AI techniques require massive amounts of data as a foundation, comprising but not limited to text data, audio data, video data and image data. In the way of obtaining data, the Internet is naturally an excellent source of data, but the variety of data available on the Internet and the need for legal compliance make it difficult and expensive to obtain data. Therefore, it is often not very easy and costly to obtain data in some specific scenarios, such as dialog data.

### SUMMARY

In order to solve the technical problems such as being difficult and expensive to collect dialog data, the present disclosure provides a method and a device for collecting dialog data.

According to a first aspect, the present disclosure provides a method for assisting users in collecting dialog data, including acquiring a feature of a dialog subject of a first dialog, wherein the dialog subject is selected from preset dialog subjects by two users participating in the first dialog, or the dialog subject is defined by the two users, and acquiring first knowledge information according to the feature of the dialog subject of the first dialog or according to the feature of the dialog subject of the first dialog and dialog data inputted by the two users, wherein the first knowledge information is used for providing background knowledge related to the first dialog to the two users.

In an optional embodiment, acquiring the first knowledge information according to the feature of the dialog subject of the first dialog or according to the feature of the dialog subject of the first dialog and the dialog data inputted by the two users includes acquiring the first knowledge information in response to acquiring the feature of the dialog subject of the first dialog, acquiring the first knowledge information in response to acquiring the feature of the dialog subject of the first dialog and receiving the dialog data, or acquiring the first knowledge information in response to receiving request information for acquiring the first knowledge information.

In an optional embodiment, acquiring the first knowledge information in response to acquiring the feature of the dialog subject of the first dialog and receiving the dialog data includes acquiring the first knowledge information immediately in response to acquiring the feature of the dialog subject of the first dialog and after receiving the dialog data, or acquiring the first knowledge information in response to acquiring the feature of the dialog subject of the first dialog and a duration of not receiving the dialog data being equal to or exceeding a preset duration after starting to receive the dialog data.

In an optional embodiment, the method further includes updating the first knowledge information according to the dialog data inputted by the two users.

In an optional embodiment, acquiring the first knowledge information includes acquiring the first knowledge information from a pre-established knowledge information database.

In a second aspect, the present disclosure provides a method for collecting dialog data, including initiating a first dialog data collection task to multiple users, in response to accepting the first dialog data collection task by two users, providing preset dialog subjects to the two users for the two users to select, in response to starting dialog data collection by the two users, executing any method in the first aspect, and receiving and saving dialog data inputted by the two users.

In an optional embodiment, the method further includes judging whether a number of dialog rounds of the dialog data reaches a preset threshold, stopping the dialog data collection and determining that the first dialog data collection task is completed when the number of dialog rounds of the dialog data reaches the preset threshold, and continuing the dialog data collection when the number of dialog rounds of the dialog data does not reach the preset threshold.

In an optional embodiment, the method further includes evaluating a completion degree of the dialog data according to a statistical method, and discarding the dialog data or marking the dialog data when the completion degree of the dialog data is lower than a preset completion degree.

In a third aspect, the present disclosure provides a device for collecting dialog data, including a processor and a memory, wherein the memory is configured to store a program instruction, and the processor is configured to invoke the program instruction to execute the method in the first aspect.

In a fourth aspect, the present disclosure provides a device for collecting dialog data, including a processor and a memory, wherein the memory is configured to store a program instruction, and the processor is configured to invoke the program instruction to execute the method in the second aspect.

In a fifth aspect, the present disclosure provides a computer-readable storage medium, wherein the computer-readable storage medium stores a program code for execution by an apparatus, and the program code is configured to execute the method in the first aspect.

In a sixth aspect, the present disclosure provides a computer-readable storage medium, wherein the computer-readable storage medium stores a program code for execution by an apparatus, and the program code is configured to execute the method in the second aspect.

In a seventh aspect, the present disclosure provides a device for assisting users in collecting dialog data, including a feature acquisition module configured for acquiring a feature of a dialog subject of a first dialog, wherein the dialog subject is selected from preset dialog subjects by two users participating in the first dialog, or the dialog subject is defined by the two users, and a knowledge information acquisition module configured for acquiring first knowledge information, according to the feature of the dialog subject of the first dialog, or according to the feature of the dialog subject of the first dialog and dialog data inputted by the two users, wherein the first knowledge information is used for providing background knowledge related to the first dialog to the two users.

In an eighth aspect, the present disclosure provides a device for collecting dialog data, including a task initiation module configured for initiating a first dialog data collection task to multiple users, a subject module configured for, in response to accepting the first dialog data collection task by two users, providing preset dialog subjects to the two users for the two users to select, a dialog collecting module configured for, in response to starting dialog data collection by the two users, executing any method in the first aspect, and a data module configured for receiving and saving dialog data inputted by the two users.

The present disclosure provides the method and device for collecting dialog data. The method provides the method for collecting dialog data between two users and the method for assisting the users in collecting dialog data. By acquiring the feature of the dialog subject of the first dialog, and according to the feature of the dialog subject of the first dialog or according to the feature of the dialog subject of the first dialog and dialog data inputted by the two users, the first knowledge information is acquired, wherein the first knowledge information is used for providing the background knowledge related to the first dialog to the two users, thus assisting the users in collecting the dialog data fluently and efficiently.

### BRIEF DESCRIPTION OF THE DRAWINGS

In order to more clearly explain some of the technical solutions of the embodiments of the present disclosure, the following will briefly introduce the drawings of the embodiments. Obviously, the drawings described below only relate to some embodiments of the present disclosure, but are not restrictive to the present disclosure.

FIG. 1 depicts a flow chart of a method for collecting dialog data provided according to at least one embodiment of the present disclosure;

FIG. 2 depicts a flow chart of a method for assisting users in collecting dialog data provided according to at least one embodiment of the present disclosure;

FIG. 3 depicts a flow chart of another method for collecting dialog data provided according to at least one embodiment of the present disclosure;

FIG. 4 depicts a schematic diagram of a device for collecting dialog data provided according to at least one embodiment of the present disclosure;

FIG. 5 depicts a schematic diagram of a device for assisting users in collecting dialog data provided according to at least one embodiment of the present disclosure; and

FIG. 6 depicts a schematic diagram of a device for collecting dialog data provided according to at least one embodiment of the present disclosure.

### DETAILED DESCRIPTION OF EXEMPLARY EMBODIMENTS

To make the objects, technical solutions, and advantages of the embodiments of the present disclosure clearer, the technical solutions of the embodiments of the present disclosure are clearly described hereinafter with reference to the drawings. The described embodiments are merely a part of, rather than all of, the embodiments of the present disclosure. Based on the embodiments of the present disclosure described, all other embodiments obtained by those having ordinary skills in the art without going through any creative work shall fall within the scope of protection of the present disclosure.

Unless otherwise defined, any technical or scientific term used in the present disclosure shall have the common meaning understood by a person of ordinary skills in the art to which the present disclosure belongs. “First”, “second”, and similar terms used in the present disclosure do not indicate any sequence, quantity, or importance, but are only used to distinguish different components. Similar words such as “comprising” or “including” mean that the elements or objects appearing before the word cover the listed elements or objects appearing after the word and equivalents thereof, without excluding other elements or objects. Such words as “connect” or “connected to” may include electrical connection, direct or indirect, rather than to be limited to physical or mechanical connection. “Up”, “down”, “left” and “right” are only used to indicate the relative positional relationship, and when an absolute position of a described object changes, the relative positional relationship may also change accordingly.

In some embodiments, the present disclosure provides a method for assisting users in collecting dialog data, including acquiring a feature of a dialog subject of a first dialog, wherein the dialog subject is selected from preset dialog subjects by multiple users participating in the first dialog, or the dialog subject is defined by the multiple users, and acquiring first knowledge information according to the feature of the dialog subject of the first dialog or according to the feature of the dialog subject of the first dialog and dialog data inputted by the multiple users, wherein the first knowledge information is used for providing background knowledge related to the first dialog to the multiple users.

In some embodiments, the present disclosure provides a method for collecting dialog data, including initiating a first dialog data collection task to multiple users, in response to accepting the first dialog data collection task by two users, providing preset dialog subjects to the two users for the two users to select, in response to starting dialog data collection by the two users, executing the method as described in any of the above embodiments, and saving dialog data inputted by the two users.

In some embodiments, the present disclosure provides a device for collecting dialog data, including a processor and a memory, wherein the memory is configured for storing a program instruction, and the processor is configured for calling the program instruction to execute the method as described in any of the above embodiments.

In some embodiments, the present disclosure provides a device for collecting dialog data, including a task initiation module configured for initiating a first dialog data collection task to multiple users, a subject module configured for, in response to accepting the first dialog data collection task by two users, providing preset dialog subjects to the two users for the two users to select, a dialog collecting module configured for, in response to starting dialog data collection by the two users, executing any method in the first aspect, and a data storage module configured for saving dialog data inputted by the two users.

In some embodiments, the present disclosure provides a computer-readable storage medium, wherein the computer-readable storage medium stores a program code for execution by an apparatus, and the program code is configured for executing any method in the first aspect.

The present disclosure provides the method and device for collecting dialog data. The method provides the method for collecting dialog data among multiple users and the method for assisting the users in collecting dialog data. By acquiring the feature of the dialog subject of the first dialog, and according to the feature of the dialog subject of the first dialog or according to the feature of the dialog subject of the first dialog and dialog data inputted by the multiple users, the first knowledge information is acquired, wherein the first knowledge information is used for providing the background knowledge related to the first dialog to the multiple users, thus assisting the users in collecting the dialog data fluently and efficiently.

FIG. 1 depicts a flow chart of a method for collecting dialog data provided according to at least one embodiment of the present disclosure.

As shown in FIG. 1, the method for collecting dialog data includes the following steps.

At step S110, a first dialog data collection task is initiated to multiple users.

For example, the first dialog data collection task is initiated to user apparatuses of the multiple users, the user apparatuses provide a display interface to the users, and the users may choose to accept or reject the first dialog data collection task through the display interface. The multiple users here may be all online users, such as 23 users. Each dialog data collection task needs two users to collect dialog data, and a specific number of users for performing the dialog data collection may be set according to actual needs, for example, 2, 3 or more. The first two users selecting to accept the first dialog data collection task in the multiple users are the users collecting the dialog data corresponding to the first dialog data collection task.

At step S120, in response to accepting the first dialog data collection task by the two users, preset dialog subjects are provided to the two users for the two users to select.

For example, after all users involving the dialog data collection accept the first dialog data collection task, all selectable dialog subjects are displayed to the users through the user apparatuses. The dialog subjects in this embodiment are preset dialog subjects, such as movies, literature, beauty, education, or the like. The preset dialog subjects may also be more specific dialog subjects, such as specific television (TV) plays, poems, mobile phones, or the like. The number of the preset dialog subjects may be very large, for example, 50,000 preset dialog subjects. A small number of dialog subjects may be firstly randomly selected from a library of dialog subjects, and then the small number of dialog subjects are provided to the users to select.

Alternatively, the dialog subject may be user-defined, for example, an input interface is provided in the display interface of the user apparatus, and the user may input the self-defined dialog subject. After two users decide to select the same one dialog subject, the dialog data collection may be started.

At step S130, dialog data inputted by the two users is received and saved.

In the process of collecting the dialog data, the dialog data inputted by the users is continuously received and saved, and the dialog data in the present disclosure is text data. After the completion of the dialog data collection task, the dialog data inputted by the two users may be associated with the dialog subject and saved. Optionally, information of the two users may also be saved together with and in addition to the dialog data and the dialog subject.

Optionally, a dialog data collection task corresponds to a number of dialog rounds, and the dialog data collection task may be ended when the number of dialog rounds of the dialog data inputted by the two users is greater than or equal to a preset number of dialog rounds. In this embodiment, the number of dialog rounds is defined as follows. Whenever two users alternately input the dialog data once, the number of dialog rounds is added by one. For example, there are two users A and B, and it may be understood that “ABA” means that after A inputs dialog data, B inputs dialog data, and then A inputs dialog data again, so that “AB” therein is one round of dialog, while “BA” therein cannot be recognized as one round of dialog, because “B” in the middle position has been counted in the last round. For another example, “ABBBB” in “ABBBBA” is regarded as one round of dialog, because there is no dialog data of the user A in “BBBB”, so the continuous “BBBB” is regarded as the dialog data of the users B and A within one round.

Alternatively, the number of dialog rounds is a fixed value, such as 25. In some other alternative embodiments, the number of dialog rounds may be set according to the demand for data, the dialog data collection efficiency, the dialog subject and the collection difficulty. For example, the number of dialog rounds ranges from 18 to 30. When the demand for data is large, the number of dialog rounds may be set to be larger, such as 30. Similarly, when the dialog data collection efficiency is low, the number of dialog rounds may also be set to be larger. For the dialog subject, the number of dialog rounds may be set according to the rarity of the dialog subject. For example, common dialog subjects correspond to a fewer number of dialog rounds. The demand for the dialog data, the dialog data collection efficiency, the dialog subject and the collection difficulty may be set according to the actual situation, and are not limited here.

In an alternative embodiment, the method for collecting dialog data further includes judging whether a number of dialog rounds of the dialog data reaches a preset threshold, if the number of dialog rounds of the dialog data reaches the preset threshold, stopping the dialog data collection and determining that the dialog data collection task is completed, and if the number of dialog rounds of the dialog data does not reach the preset threshold, continuing the dialog data collection.

For example, the number of dialog rounds is counted, and the number of dialog rounds and the preset threshold are judged once for each additional round. When the number of dialog rounds reaches the preset threshold, it is determined that the dialog data collection task is completed and the user is informed that the dialog data collection is completed. For another example, the number of dialog rounds and the preset threshold are judged once for every preset time interval. When the number of dialog rounds reaches the preset threshold, it is determined that the dialog data collection task is completed and the user is informed that the dialog data collection is completed. For example, a judgment is made every 1 minute.

In another alternative embodiment, the user may select to end the dialog data collection task. After the user ends the dialog data collection task, it is judged whether the number of dialog rounds of the collected dialog data is greater than or equal to the preset threshold. It is determined that the dialog data collection task is completed if the number of dialog rounds of the collected dialog data is greater than or equal to the preset threshold. It is determined that the dialog data collection task is not completed if the number of dialog rounds of the collected dialog data is not greater than or equal to the preset threshold and thus the collected dialog data is marked or the collected dialog data is discarded.

In an alternative embodiment, the method for collecting dialog data further includes evaluating a completion degree of the dialog data according to a statistical method, and discarding the dialog data or marking the dialog data when the completion degree of the dialog data is lower than a preset completion degree.

For example, in the process of collecting the dialog data, a duration of the dialog data collection task executed by the user may be recorded. The duration distributions of all dialog data collection tasks are counted, such as normal distribution, Gaussian distribution. A position of the duration of executing each dialog data collection task in the counted duration distribution is determined. It is determined that the completion degree of the dialog data collected by the dialog data collection task is low if the duration appears in a position with low probability. As another example, reliability and validity analysis may be used to evaluate the completion degree of the dialog data. For example, according to the Cronbach α coefficient or other indicators, the reliability and validity analysis is carried out on the collected dialog data to determine whether the completion degree of the collected dialog data is within a valid range.

This embodiment provides a simple and feasible method for collecting dialog data, and can evaluate the collected dialog data. However, in use, there are cases of low dialog data collection efficiency and low completion degree of the dialog data caused by unfamiliarity with the dialog subjects of the users. For example, for users who are not familiar with scientific and technological dialog subjects, the time of collecting the dialog data may be long, or the content of the dialog data may be essentially irrelevant to science and technology because the users are not familiar with relevant information and knowledge. The dialog data collected in this way may be of low quality, and may lead to poor model training effect when it is applied to model training.

In order to further improve the dialog data collection efficiency and the quality of the collected dialog data, the present disclosure further provides a method for assisting users in collecting dialog data.

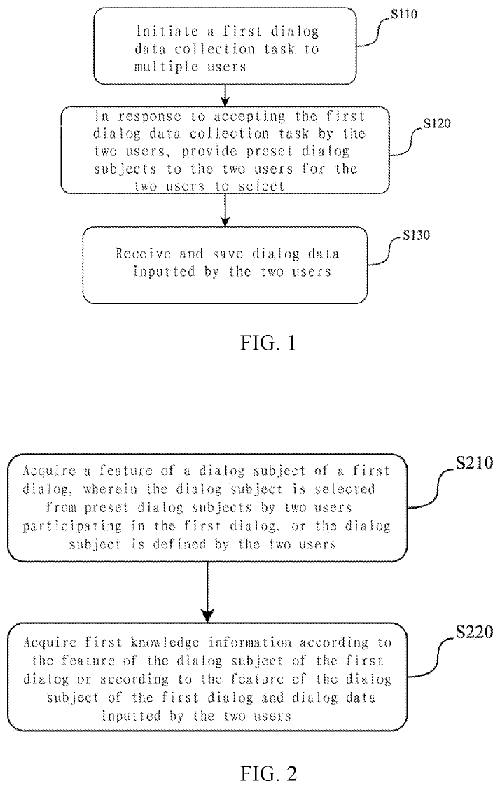

FIG. 2 depicts a flow chart of a method for assisting users in collecting dialog data provided according to at least one embodiment of the present disclosure.

As shown in FIG. 2, the method for assisting users in collecting dialog data includes the following steps.

At step S210, a feature of a dialog subject of a first dialog is acquired, wherein the dialog subject is selected from preset dialog subjects by two users participating in the first dialog, or the dialog subject is defined by the two users.

For example, the dialog subject is selected by two users from 10 displayed preset dialog subjects. The 10 dialog subjects may be randomly obtained from a dialog subject library. For example, the dialog subject library has 35,000 dialog subjects, from which 10 dialog subjects are randomly selected for the users to select. In this embodiment, the feature of the dialog subject is the keyword of the dialog subject. For example, if the dialog subject is a science fiction movie, the corresponding features can be “science fiction” and “movie”.

At step S220, first knowledge information is acquired according to the feature of the dialog subject of the first dialog, or according to the feature of the dialog subject of the first dialog and dialog data inputted by the two users, wherein the first knowledge information is used for providing background knowledge related to the first dialog to the two users.

The first knowledge information in this embodiment may be a knowledge graph, definitions of keywords, and the like. After acquiring the first knowledge information, the first knowledge information is displayed to the user, for example, the first knowledge information is displayed in a display interface of a user apparatus.

When executing step S220, the first knowledge information may be acquired in response to the acquired feature of the dialog subject of the first dialog. That is, the first knowledge information is automatically acquired after the dialog subject is determined, so that the first knowledge information may be informed to the user at the beginning of the dialog data collection.

Alternatively, the first knowledge information is acquired immediately in response to acquiring the feature of the dialog subject of the first dialog and after receiving the dialog data.

In another implementation, the first knowledge information is acquired in response to acquiring the feature of the dialog subject of the first dialog and receiving the dialog data. In this implementation, the acquired first knowledge information may have too much content if only the feature of the dialog subject is used to acquire the first knowledge information. Therefore, after the user starts the dialog, acquiring the first knowledge information according to the dialog data inputted by the user and the feature of the dialog subject can effectively reduce the amount of information, thus providing more accurate help.

Alternatively, the first knowledge information may be acquired, in response to acquiring the feature of the dialog subject of the first dialog and a duration of not receiving the dialog data being equal to or exceeding a preset duration after starting to receive the dialog data. For example, it is possible to time an interval between the dialog data inputted by the user, so as to acquire the first knowledge information for the user when the user does not input dialog data for a long time, thus helping collect the dialog data smoothly.

In another implementation, the first knowledge information may also be acquired in response to receiving request information for acquiring the first knowledge information. In this implementation, the acquisition of the first knowledge information may be triggered according to the requests of the users, and resources used to acquire the first knowledge information can be saved for some users who do not need help.

Alternatively, the first knowledge information may be updated according to the dialog data inputted by the two users. When the first knowledge information is already acquired, new knowledge information can be further acquired according to a content of the dialog data inputted by the user, thus providing help to the user in real time.

Alternatively, when executing step S220, the first knowledge information may be acquired from a pre-established knowledge information library. For example, retrieval is performed in a knowledge information library, according to the feature of the dialog subject and/or key terms or keywords extracted from the dialog subject. In a further example, the first knowledge information may be searched from the Internet, according to the feature of the dialog subject and/or the key terms or keywords extracted from the dialog subject.

Optionally, the user may be provided with an interface connected to the Internet so that the user can directly search the first knowledge information from the Internet.

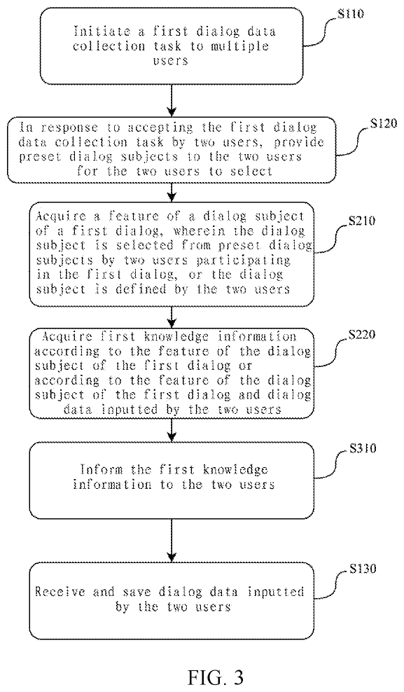

FIG. 3 depicts a flow chart of another method for collecting dialog data provided according to at least one embodiment of the present disclosure.

The method for collecting dialog data in this embodiment combines the methods shown in FIG. 1 and FIG. 2, in which the same reference numerals indicate the same steps.

As shown in FIG. 3, the method for collecting dialog data includes the following steps.

At step S110, a first dialog data collection task is initiated to multiple users.

At step S120, in response to accepting the first dialog data collection task by the two users, preset dialog subjects are provided to the two users for the two users to select.

At step S210, a feature of a dialog subject of a first dialog is acquired, wherein the dialog subject is selected from preset dialog subjects by two users participating in the first dialog, or the dialog subject is defined by the two users.

At step S220, first knowledge information is acquired according to the feature of the dialog subject of the first dialog, or according to the feature of the dialog subject of the first dialog and dialog data inputted by the two users, wherein the first knowledge information is used for providing background knowledge related to the first dialog to the two users.

At step S310, the first knowledge information is informed to the two users.

At step S130, dialog data inputted by the two users is received and saved.

The executing manner of the method in FIG. 3 is known from the related descriptions of FIG. 1 and FIG. 2, and thus will not be repeated here. It should be noted that the step S210 may be executed immediately after the step S120 is executed, or the step S220 may be executed, after the user starts to collect the dialog data, in response to the start of the dialog data collection.

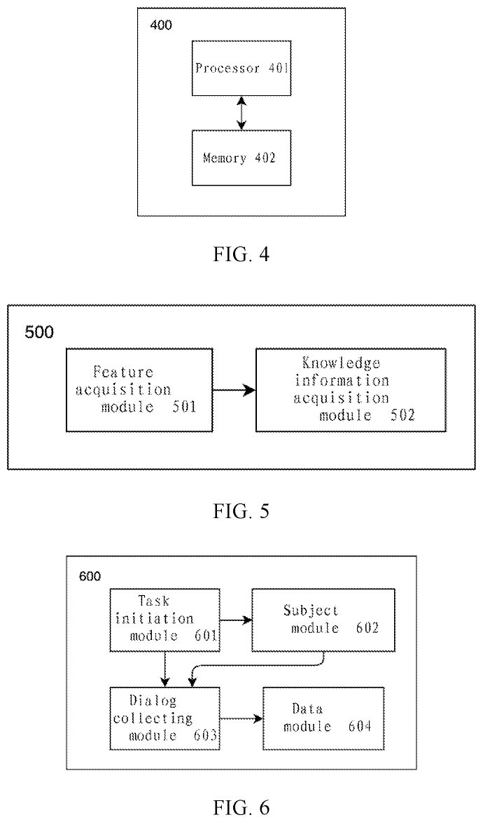

FIG. 4 depicts a schematic diagram of a device for collecting dialog data provided according to at least one embodiment of the present disclosure.

In FIG. 4, the device 400 for collecting dialog data includes a processor 401 and a memory 402. The memory 402 is configured for storing a program instruction, and the processor 401 is configured for calling the program instruction to execute the method described in any of the above embodiments.

FIG. 5 depicts a schematic diagram of a device for assisting users in collecting dialog data provided according to at least one embodiment of the present disclosure.

In FIG. 5, the device 500 for assisting users in collecting dialog data includes a feature acquisition module 501 configured for acquiring a feature of a dialog subject of a first dialog, wherein the dialog subject is selected from preset dialog subjects by two users participating in the first dialog, or the dialog subject is defined by the two users, and a knowledge information acquisition module 502 configured for acquiring first knowledge information, according to the feature of the dialog subject of the first dialog or according to the feature of the dialog subject of the first dialog and dialog data inputted by the two users, wherein the first knowledge information is used for providing background knowledge related to the first dialog to the two users.

The device 500 for assisting users in collecting dialog data may execute the method described in FIG. 2, and the details may be referred to the above description and thus will not be repeated here.

FIG. 6 depicts a schematic diagram of a device for collecting dialog data provided according to at least one embodiment of the present disclosure.

In FIG. 6, the device 600 for collecting dialog data includes a task initiation module 601 configured for initiating a first dialog data collection task to multiple users, a subject module 602 configured for, in response to accepting the first dialog data collection task by two users, providing preset dialog subjects to the two users for the two users to select, a dialog collecting module 603 configured for, in response to starting dialog data collection by the two users, executing the method for assisting users in collecting dialog data as described above, and a data module 604 configured for receiving and saving dialog data inputted by the two users.

The device 600 for collecting dialog data may execute the method described in FIG. 3, and the specific execution method may be referred to the above description and thus will not be repeated here.

In some alternative embodiments, the present disclosure provides a computer-readable storage medium, wherein the computer-readable storage medium stores a program code for execution by an apparatus, and the program code is configured to execute the method in any of the above method embodiments.

The various illustrative logical blocks, modules, circuits, and algorithmic operations described in connection with the embodiments disclosed herein may be implemented as electronic hardware, computer software, or combinations of both. To clearly illustrate this interchangeability of hardware and software, various illustrative components, blocks, modules, circuits and operations have been described above generally according to functions thereof. Whether this function is implemented as hardware or software depends on the specific application and the design constraints imposed on the whole system. Skilled technicians can implement the described functions in different ways for each specific application, but this implementation decision should not be interpreted as causing a deviation from the scope of the claims.

Hardware for implementing various illustrative logics, logic blocks, modules and circuits described in connection with the embodiments disclosed herein may be implemented or executed with a general-purpose processor, a digital signal processor (DSP), an application-specific integrated circuit (ASIC), a field-programmable gate array (FPGA) or other programmable logic devices, discrete gate or transistor logic, discrete hardware components, or any combination designed to perform the functions described herein. The general-purpose processor may be a microprocessor, but in an alternative solution, the processor may be any conventional processor, controller, microcontroller or state machine. The processor may also be implemented as a combination of computing devices, for example, a combination of a DSP and a microprocessor, a plurality of microprocessors, one or more microprocessors combined with a DSP core, or any other such configuration. Alternatively, some operations or methods may be performed by circuits specific to a given function.

In one or more embodiments, the described functions may be implemented in hardware, software, firmware or any combination thereof. If implemented in software, these functions may be stored as one or more instructions or codes on a non-transitory computer-readable medium or a non-transitory processor-readable medium. Operations of the methods or algorithms disclosed herein may be embodied in a processor-executable software module, which may reside on a non-transitory computer-readable or processor-readable storage medium. The non-transitory computer-readable or processor-readable storage medium may be any storage media that can be accessed by a computer or a processor. By way of example rather than limitation, such non-transitory computer-readable or processor-readable medium may include random-access memory (RAM), read-only memory (ROM), electrically erasable programmable ROM (EEPROM), flash memory, compact disc (CD) ROM (CD-ROM) or other optical disc memory, magnetic disk memory or other magnetic storage devices, or any other medium that can be used to store desired program codes in the form of instructions or data structures and can be accessed by computers. As used herein, discs comprise CD, laser discs, optical discs, DIGITAL VERSATILE DISCs (DVDs), floppy disks, and BLU-RAY discs, while the discs reproduce data magnetically or optically by laser. Combinations of the above are also comprised in the scope of non-transitory computer-readable and processor-readable media. In addition, the operations of a method or algorithm may reside as one or any combination or set of codes and/or instructions on a non-transitory processor-readable medium and/or computer-readable medium, which may be incorporated into a computer program product.

The foregoing description of the disclosed embodiments is provided to enable any person skilled in the art to make or use the claims. Various modifications to these embodiments will be obvious to those skilled in the art, and the general principles defined herein may be applied to other embodiments without departing from the scope of the claims. Therefore, the present disclosure is not intended to be limited to the embodiments shown herein, but is to be accorded the widest scope consistent with the claims and the principles and novel features disclosed herein.

What is claimed is:

1. A method implemented by a processor of a device, wherein the method comprises:
acquiring a feature of a dialog subject of a first dialog, wherein the dialog subject is either selected from preset dialog subjects by two users participating in the first dialog or defined by the two users; and
acquiring first knowledge information according to either the feature or the feature and dialog data received from the two users, wherein the first knowledge information is used for providing background knowledge related to the first dialog to the two users.

2. The method of 1, wherein acquiring the first knowledge information comprises:
further acquiring the first knowledge information in response to acquiring the feature;
further acquiring the first knowledge information in response to acquiring the feature and receiving the dialog data; or
further acquiring the first knowledge information in response to receiving request information for acquiring the first knowledge information.

3. The method of claim 2, wherein acquiring the first knowledge information further comprises further acquiring the first knowledge information from a pre-established knowledge information library.

4. The method of claim 2, wherein acquiring the first knowledge information further comprises:
further acquiring the first knowledge information in response to acquiring the feature and after receiving the dialog data; or
further acquiring the first knowledge information, in response to acquiring the feature and a duration of not receiving the dialog data being equal to or exceeding a preset duration after starting to receive the dialog data.

5. The method of claim 4, wherein acquiring the first knowledge information further comprises further acquiring the first knowledge information from a pre-established knowledge information library.

6. The method of claim 1, further comprising updating the first knowledge information according to the dialog data.

7. The method of claim 6, wherein acquiring the first knowledge information comprises further acquiring the first knowledge information from a pre-established knowledge information library.

8. The method of claim 1, wherein acquiring the first knowledge information comprises further acquiring the first knowledge information from a pre-established knowledge information library.

9. A method implemented by a processor of a device, wherein the method comprises:
initiating a dialog data collection task to a plurality of users;
providing, in response to accepting the dialog data collection task by two users of the plurality of users, preset dialog subjects to the two users for the two users to select; and
in response to the two users starting dialog data collection:
acquiring a feature of a dialog subject of a first dialog, wherein the dialog subject is either selected from the preset dialog subjects by the two users or defined by the two users; and
acquiring first knowledge information either according to the feature or according to the feature and dialog data received from the two users, wherein the first knowledge information is used for providing background knowledge related to the first dialog to the two users; and
saving the dialog data.

10. The method of claim 9, further comprising:
determining whether a number of dialog rounds of the dialog data has reached a preset threshold;
when the number of dialog rounds has reached the preset threshold:
stopping the dialog data collection; and
determining that the dialog data collection task is completed; and
continuing the dialog data collection when the number of dialog rounds does not reach the preset threshold.

11. The method of claim 9, further comprising:
evaluating a completion degree of the dialog data according to a statistical method; and
discarding the dialog data or marking the dialog data when the completion degree is lower than a preset completion degree.

12. The method of claim 9, wherein acquiring the first knowledge information comprises:
further acquiring the first knowledge information in response to acquiring the feature;
further acquiring the first knowledge information in response to acquiring the feature and receiving the dialog data; or
further acquiring the first knowledge information in response to receiving request information for acquiring the first knowledge information.

13. The method of claim 12, wherein acquiring the first knowledge information further comprises:
further acquiring the first knowledge information in response to acquiring the feature and after receiving the dialog data; or
further acquiring the first knowledge information, in response to acquiring the feature and a duration of not receiving the dialog data being equal to or exceeding a preset duration after starting to receive the dialog data.

14. The method of claim 9, further comprising updating the first knowledge information according to the dialog data.

15. The method of claim 9, wherein acquiring the first knowledge information comprises further acquiring the first knowledge information from a pre-established knowledge information library.

16. A device comprising:
a memory configured to store instructions; and
a processor coupled to the memory and configured to execute the instructions to cause the device to:
acquire a feature of a dialog subject of a first dialog, wherein the dialog subject is either selected from preset dialog subjects by two users participating in the first dialog or defined by the two users; and
acquire first knowledge information according to either the feature or the feature and dialog data received from the two users, wherein the first knowledge information is used for providing background knowledge related to the first dialog to the two users.

17. The device of claim 16, wherein the processor is further configured to execute the instructions to cause the device to:
further acquire the first knowledge information in response to acquiring the feature;
further acquire the first knowledge information in response to acquiring the feature and receiving the dialog data;
further acquire the first knowledge information in response to receiving request information for acquiring the first knowledge information.

18. The device of claim 17, wherein the processor is further configured to execute the instructions to cause the device to:
further acquire the first knowledge information in response to acquiring the feature and after receiving the dialog data; or
further acquire the first knowledge information, in response to acquiring the feature and a duration of not receiving the dialog data being equal to or exceeding a preset duration after starting to receive the dialog data.

19. A computer program product comprising computer-executable instructions that are stored on a non-transitory computer-readable storage medium and that, when executed by a processor, cause an apparatus to:
acquire a feature of a dialog subject of a first dialog, wherein the dialog subject is either selected from preset dialog subjects by two users participating in the first dialog or defined by the two users;
acquire first knowledge information according to either the feature or the feature and dialog data received from the two users, wherein the first knowledge information is used for providing background knowledge related to the first dialog to the two users.

20. The computer program product of claim 19, wherein the computer-executable instructions further cause the apparatus to:
further acquire the first knowledge information in response to acquiring the feature;
further acquire the first knowledge information in response to acquiring the feature and receiving the dialog data; or
further acquire the first knowledge information in response to receiving request information for acquiring the first knowledge information.
